(19) United States
(12) Patent Application Publication
(10) Pub. No.: US 2025/0355817 A1
(43) Pub. Date: Nov. 20, 2025

(54) VARIABLE ACTIVATION TIME DELAY FOR WRITE MODES

(71) Applicant: Micron Technology, Inc., Boise, ID (US)

(72) Inventor: Jaeil Kim, Suwanee, GA (US)

(21) Appl. No.: 19/202,983

(22) Filed: May 8, 2025

Related U.S. Application Data
(60) Provisional application No. 63/649,248, filed on May 17, 2024.

(51) Int. Cl. G06F 13/16

(52) U.S. Cl. CPC G06F 13/16; G06F 2213/16

(57) ABSTRACT

Methods, systems, and devices for variable activation time delay for write modes are described. A memory system may include delay adjustment circuitry to determine and generate a delay for write operations associated with one or more write modes. The delay adjustment circuitry may include circuitry to calibrate enable signals based on timing parameters, circuitry to generate control signals based on the enable signals, and circuitry to apply a variable delay to a write operation based on the control signals. The circuitry may include multiple delay subcircuits each including at least one delay element, where the delay elements may be activated or deactivated based on the control signals in order to generate a variable delay. In some cases, the timing parameters may be based on one or more of an initialization command, a frequency change command, a nonoperational command, or a clock signal associated with the memory system.

### CROSS REFERENCE

The present application for patent claims priority to U.S. Patent Application No. 63/649,248 by Kim, entitled “VARIABLE ACTIVATION TIME DELAY FOR WRITE MODES,” filed May 17, 2024, which is assigned to the assignee hereof, and which is expressly incorporated by reference in its entirety herein.

### TECHNICAL FIELD

The following relates to one or more systems for memory, including variable activation time delay for write modes.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports variable activation time delay for write modes in accordance with examples as disclosed herein.

FIG. 2A shows an example of a bank group and data bus configuration that supports variable activation time delay for write modes in accordance with examples as disclosed herein.

FIG. 2B shows an example of a timing diagram that supports variable activation time delay for write modes in accordance with examples as disclosed herein.

FIG. 3 shows an example of an enable signal calibration circuit that supports variable activation time delay for write modes in accordance with examples as disclosed herein.

FIG. 4 shows an example of a control signal generation circuit that supports variable activation time delay for write modes in accordance with examples as disclosed herein.

FIG. 5 shows an example of a timing diagram that supports variable activation time delay for write modes in accordance with examples as disclosed herein.

FIG. 6 shows an example of a delay circuit that supports variable activation time delay for write modes in accordance with examples as disclosed herein.

FIG. 7 shows a block diagram of a memory system that supports variable activation time delay for write modes in accordance with examples as disclosed herein.

FIG. 8 shows a flowchart illustrating a method or methods that support variable activation time delay for write modes in accordance with examples as disclosed herein.

### DETAILED DESCRIPTION

In some cases, a memory system may perform write operations associated with different write modes and different burst lengths. For example, a memory system may support a first write mode associated with a first burst length and a second write mode associated with a second burst length that is different than the first burst length. The burst lengths may correspond to quantities or amounts of data (e.g., bits) that are conveyed via a data bus within a single transmission burst. In some cases, a write window between consecutive writes may not be sufficient to communicate a set of data based on a write mode of the consecutive writes, which may reduce reliability at the memory system. For example, if the memory system performs a first write operation and a second write operation consecutively and on a same set of banks in the memory system, a transfer of first data as part of the first write operation may be initiated via a clock signal (e.g., based on a clock-based enable indication that enables a data bus associated with the set of banks), and the second write operation may be initiated via a data query strobe (DQS) signal (e.g., based on a DQS signal at a time at which a second write command is received) based on accessing a same set of banks consecutively. However, an asynchrony between the clock signal and the DQS signal may shorten the write window, in some cases. Further to account for a difference in burst lengths for data written according to different write modes (e.g., burst chop 8 (BC8), burst length 16 (BL16), or other burst lengths), the memory system may add a time delay to some write operations (e.g., BC8 write operations). However, the time delay may vary for different write operations, which may additionally, or alternatively, shorten the write window. Thus, the asynchrony between the clock signal and the data strobe signal (e.g., skew), the variation in the time delay, or both, may cause the write window of a write operation to be shortened, such that write data associated with the two consecutive write operations may overlap or interfere, or write data associated with the write operations may otherwise not be transmitted correctly during the shortened write window.

According to techniques described herein, a memory system may include delay adjustment circuitry configured to determine and generate a delay for write operations associated with one or more write modes (e.g., one or more burst lengths, BC8, BL16). The delay adjustment circuitry may include circuitry to calibrate one or more enable signals for a write mode based on one or more timing parameters (e.g., an enable signal calibration circuit), circuitry to generate one or more control signals based on the one or more enable signals (e.g., a control signal generation circuit), and circuitry to apply a variable delay to a write operation based on the control signals (e.g., a delay circuit). For example, the delay circuit may include a plurality of delay subcircuits each including at least one delay element, where the delay elements may be activated or deactivated based on the control signals in order to generate a delay having a variable duration. In some cases, the timing parameters may be based on an initialization command (e.g., TINIT1, PwrUpRst), a frequency change command (tCSL_FreqChg, CLKSREFB), a nonoperational command, a clock signal associated with the memory system, or any combination thereof.

In addition to applicability in memory systems as described herein, techniques for variable activation time delay for write modes may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by mitigating the negative effects on performance that variations in a delay associated with some write modes (e.g., BC8) may cause on a memory system. Such techniques may ensure that a write duration is long enough to transfer a quantity of data, which may increase data reliability and decrease latency in the memory system, among other benefits.

Features of the disclosure are illustrated and described in the context of systems and architectures. Features of the disclosure are further illustrated and described in the contexts of bank group and data bus configurations, timing diagrams, circuit diagrams (e.g., schematics), and flowcharts. As used herein, an “activated” signal may refer to a signal at a voltage that indicates activation, such as a high voltage. Although some examples herein illustrate a high voltage as an active signal, a low voltage may also indicate activation of a signal in some cases. Additionally, any quantity of elements, circuits, subcircuits, signals, or commands described herein may be merely exemplary, and is in no way limiting to the techniques described herein.

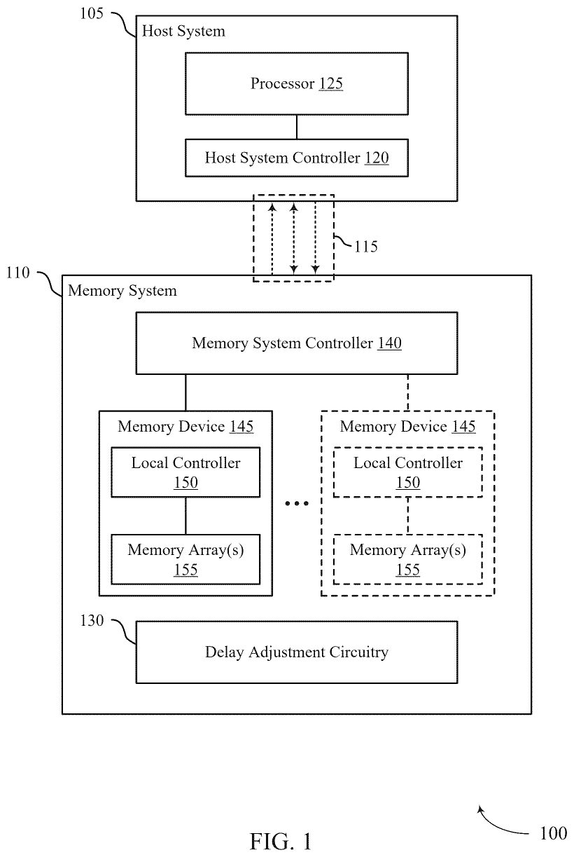

FIG. 1 illustrates an example of a system 100 that supports variable activation time delay for write modes in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some cases, A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

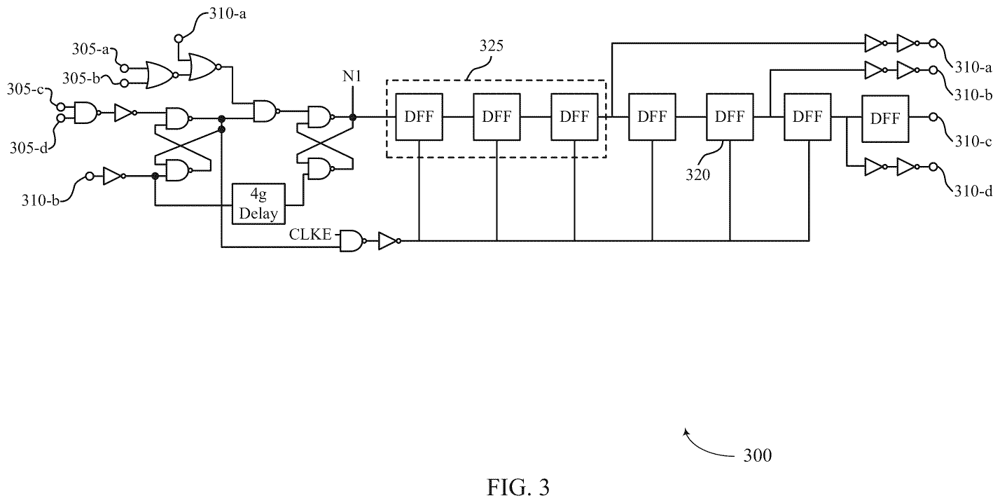

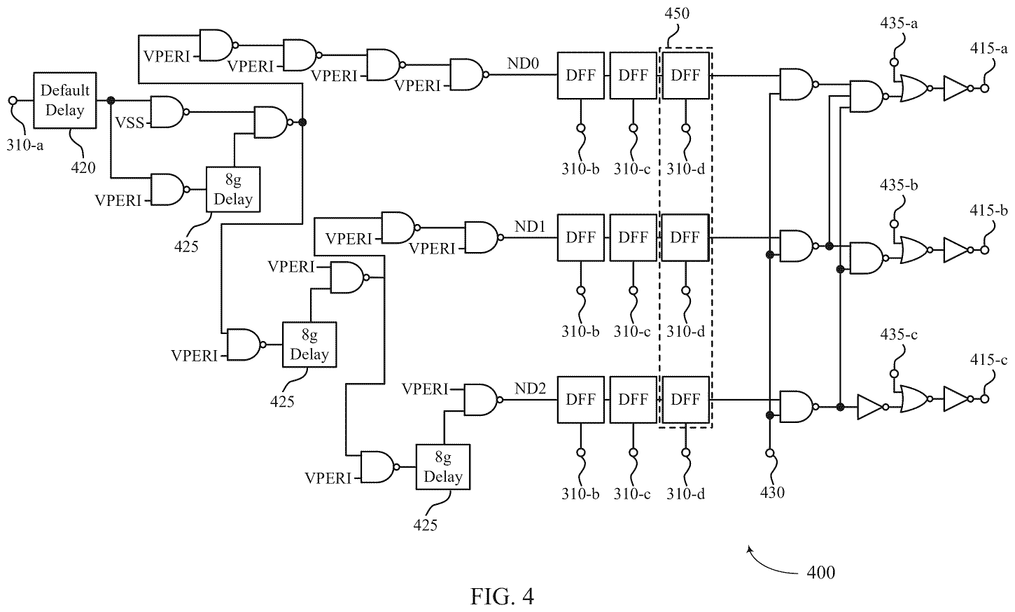

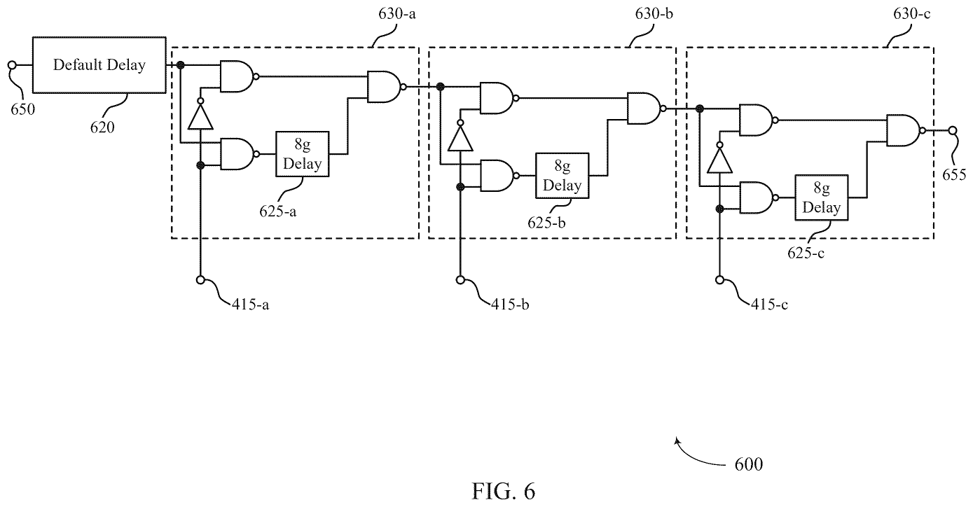

In some cases, the memory system 110 may include delay adjustment circuitry 130 dedicated to determining a delay for write operations associated with one or more write modes (e.g., one or more burst lengths, BC8, BL16). In some cases, the delay adjustment circuitry 130 may prevent a write window associated with a set of banks within the memory system 110 from being too short (e.g., reducing reliability of the data) due to, for example, consecutive write operations of a same or different write modes (e.g., BC8). The delay adjustment circuitry 130 may include an enable signal calibration circuit (e.g., as described herein with respect to FIG. 3), a control signal generation circuit (e.g., as described herein with respect to FIG. 4), and a delay circuit (e.g., as described herein with respect to FIG. 6). For example, the delay circuit may include a plurality of delay subcircuits each including at least one delay element (e.g., an 8g delay element), where the delay elements may be activated or deactivated based on the control signals in order to generate a variable delay. Although illustrated within the memory system 110, it is to be understood that the delay adjustment circuitry 130 may be included in the memory system controller 140 or any one or more of the memory devices 145. Additionally, or alternatively, the delay adjustment circuitry 130 may be distributed in one or more different locations throughout the memory system.

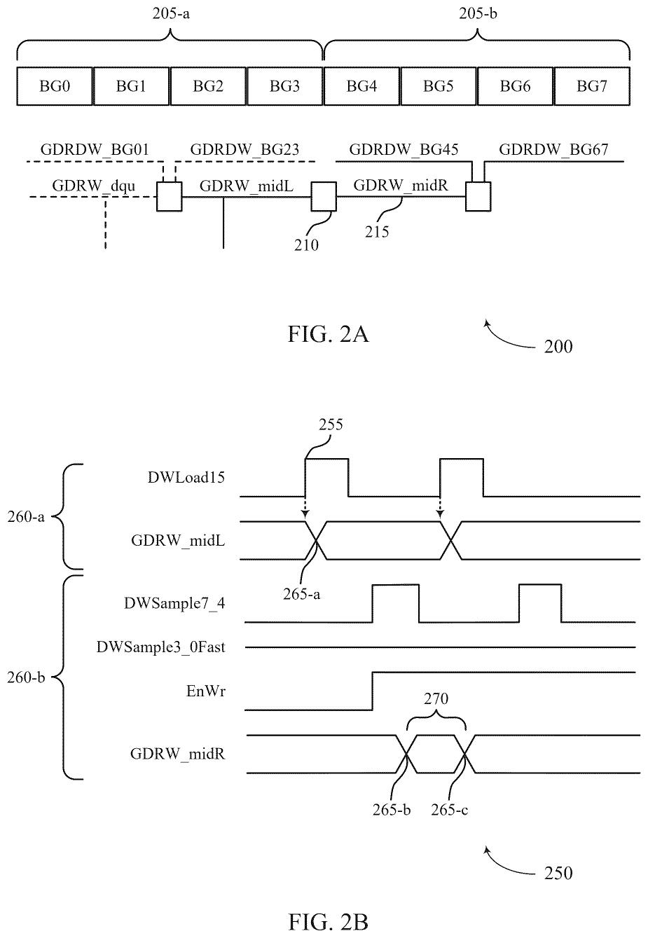

FIG. 2A shows an example of a bank group and data bus configuration 200 that supports variable activation time delay for write modes in accordance with examples as disclosed herein, and FIG. 2B shows an example of a timing diagram 250 that supports variable activation time delay for write modes in accordance with examples as disclosed herein. For example, signaling shown in the timing diagram 250 may be associated with performing consecutive write operations in a set of banks 205-b as illustrated in the bank group and data bus configuration 200. In some cases, aspects of the bank group and data bus configuration 200 and the timing diagram 250 may implement or be implemented by aspects of FIG. 1. For example, the bank group and data bus configuration 200 may include one or more sets of banks 205 (e.g., sets of bank groups, a set of banks 205-a, a set of banks 205-b), which may be examples of the banks (e.g., memory banks) of the memory system 110 as described herein with respect to FIG. 1. In some aspects, the bank group and data bus configuration 200 and the timing diagram 250 may illustrate a scenario for application of variable activation time delay for write modes.

A memory system (e.g., the memory system 110) may include the bank group and data bus configuration 200 within one or more memory devices. Each set of banks 205 may include one or more bank groups (e.g., BG), where each bank group may include one or more memory cells. For example, the set of banks 205-a may include bank group 0 (BG0), bank group 1 (BG1), bank group 2 (BG2), and bank group 3 (BG3), and the set of banks 205-b may include bank group 4 (BG4), bank group 5 (BG5), bank group 6 (BG6), and bank group 7 (BG7) in this example. It is to be understood that different sets of bank groups may be included in a memory device, and each set may include any quantity or combination of banks. The quantity of bank groups per set of banks 205 may be merely exemplary.

The bank group and data bus configuration 200 may include one or more different channels for accessing each set of banks 205. For example, the bank group and data bus configuration 200 may include a data bus 215 configured to communicate data with one or more of the sets of banks 205 (e.g., with one or more bank groups of the set of banks 205-b). For example, the data bus 215 may include one or more solid line sections illustrated in the bank group and data bus configuration 200 (e.g., as opposed to the dashed line section), which may carry one or more signals (e.g., global data read write (GDRW) middle left (GDRW_midL), GDRW middle right (GDRW_midR), global data read data write (GDRDW) for bank groups 4 and 5 (GDRDW_BG45), and GDRDW for bank groups 6 and 7 (GDRDW_BG67)) to the set of banks 205-b. A second data bus or portion of the data bus (e.g., the dashed line section) may be associated with accessing the set of banks 205-a.

In some cases, a repeater 210 may be coupled with the data bus 215. The repeater 210 may be configured to forward one or more data signals (e.g., data, signals indicating data) via the data bus 215 to a set of banks 205 (e.g., the set of banks 205-b) according to one or more write modes. For example, the repeater 210 may forward data signals to one or more bank groups within the set of banks 205-b according to a first write mode (e.g., BC8) based at least in part on a first write operation, and may forward a second data signal to one or more bank groups within the set of banks 205-b according to the first write mode based at least in part on a second write operation. In some cases, the one or more bank groups associated with the first write operation may be the same or different from the one or more bank groups associated with the second write operation. Additionally, or alternatively, the repeater 210 may configure the bank group and data bus configuration 200 to transmit data signals to the set of banks 205-a.

The timing diagram 250 may illustrate one or more signals for performing write operations associated with the bank group and data bus configuration 200. Although example signals are labeled and described in FIG. 2B, it is to be understood that any combination of one or more timing signals may be included or otherwise associated with operations of the bank group and data bus configuration 200, including the signals described herein or other signals not illustrated.

A value of an enable write (EnWr) signal may indicate to which set of banks 205 data is being written. A data write sample signal (DWSample) for bank groups 7 through 4 (DWSample7_4) and a DWSample for bank groups 3 through 0 (DWSample3_0Fast) may activate and deactivate the EnWr signal, respectively, such that an activated EnWr may be associated with writing data to the set of banks 205-b, and a deactivated EnWr may be associated with writing data to the set of banks 205-a. In some examples, the EnWr signal may enable or disable the repeater 210 illustrated in FIG. 2A. Activation of a data write load 15 signal (DWLoad15) may cause a transition 265-a of GDRW_midL, which may trigger the activation of DWSample7_4 or DWSample3_0Fast to write to either the set of banks 205-b or the set of banks 205-a, respectively. In some cases, a set of signals 260-a (e.g., DWLoad15, GDRW_midL) may be within a DQS domain of the memory system (e.g., being driven by the DQS signal), and a set of signals 260-b (e.g., DWSample7_4, DWSample3_0Fast, EnWr, GDRW_midR) may be within a clock (e.g., CLK) domain of the memory system (e.g., being driven by a clock signal).

In some cases, consecutive write operations associated with the bank group and data bus configuration 200 may be associated with different sets of banks 205. In such cases, DWSample7_4 may enable EnWr to accomplish a first write operation to the set of banks 205-b, and DWSample3_0Fast may disable EnWr to accomplish a second write operation to the set of banks 205-a.

In some cases, the memory system may be configured with a data query strobe setting minimum time (tDQSSmin) and a data query strobe minimum offset time (tDQSoffsetmin), which may indicate a timing position of a data query strobe (DQS) of the memory system relative to a clock of the memory system. For example, tDQSSmin may be associated with a drift window of the DQS from a clock of the memory system based on a voltage, temperature, or both, associated with the memory system, a host system, or both. DWSample7_4 and DWSample3_0 may maintain a same timing whether the memory system is configured with one or more of tDQSSmin and tDQSoffsetmin. However, a timing of DWload15 may become earlier (e.g., move to the left in the timing diagram 250) if the memory system is configured with one or more of tDQSSmin and tDQSoffsetmin. For example, a transition of a GDRW signal (e.g., similar to a transition 265-a of GDRW_midL) associated triggered by the earlier DWLoad15 may occur while the EnWr is activated, which may trigger a subsequent write operation to occur sooner than expected (e.g., shortening a write window 270).

In some cases, the memory system may perform consecutive write operations according to a same write mode (e.g., a first write mode) or different write modes. For example, the memory system may support a plurality of write modes, including at least a first write mode and a second write mode. The first write mode (e.g., BC8) may be associated with a burst length of eight bits, and the second write mode (e.g., BL16) may be associated with a burst length of sixteen bits.

When the memory system processes a write operation according to the first write mode (e.g., BC8), DWload15 may follow a timing of a column access strobe (CAS) write latency (CWL), plus a first defined quantity of clock cycles (e.g., 3.5 clock cycles, or some other quantity), plus a time delay. Alternatively, when the memory system processes a write operation according to the second write mode (e.g., BL16), DWload15 may follow a timing of a CWL, plus a second defined quantity of clock cycles (e.g., 7.5 clock cycles, or some other quantity), plus a time delay. When the memory system operates according to fast process and high voltage (JFF&HVDD), a value of the time delay may be shortened. Thus, the timing of DWload15 may be moved earlier (e.g., move to the left in the timing diagram 250) for the first write mode compared to the second write mode, which may also cause a transition of a GDRW signal (e.g., GDRW_midL, GDRW_midR) associated with a second write operation to occur while EnWr is activated.

In some cases, as illustrated in the timing diagram 250, a first write operation and a second write operation may be consecutive write operations associated with a same set of banks 205 (e.g., the set of banks 205-b). For example, at a time 255, the memory system may initiate a first write operation associated with the set of banks 205-b. If the memory system performs the first write operation and the second write operations according to the second write mode (e.g., BL16), a transition 265-b of GDRW_midR (e.g., beginning a transfer of data associated with the first write operation) may be triggered by DWSample7_4 (e.g., within the CLK domain) and performed according to a write latency plus eight clock cycles, or some other default quantity of clock cycles per write. However, because the second write operation is a consecutive write operation to a same set of banks 205 (e.g., thus EnWr is already activated), a transition 265-c of GDRW_midR (e.g., beginning a transfer of data associated with the second write operation) may be triggered by DWload15 (e.g., within the DQS domain) and performed according to the write latency plus the second defined quantity of clock cycles (e.g., 7.5 clock cycles). Therefore, an asynchrony of the clock domain and the DQS domain may shorten the write window 270 (e.g., a valid period, data window) in some examples based on the consecutive writes to the set of banks 205-b.

Additionally, or alternatively, when the memory system performs write operations according to the first write mode (e.g., BC8) and a write latency plus the first defined quantity of clock cycles (e.g., 3.5 clock cycles), the memory system may add a time delay to the write operation to attempt to compensate for the shorter quantity of clock cycles. The time delay may attempt to satisfy a threshold quantity of clock cycles (e.g., four clock cycles, or some other quantity based on a difference between the second defined quantity of clock cycles associated with the second write mode and the first defined quantity of clock cycles associated with the first write mode), but the time delay may fall short of the threshold quantity of clock cycles when EnWr is activated (e.g., when EnWr is at a high voltage level), which may shorten the write window 270.

As described herein, a memory system may include delay adjustment circuitry to apply a variable activation time delay for write modes of write operations. The delay adjustment circuitry may determine and generate a variable delay for write operations based on one or more parameters associated with the memory system, as described in further detail elsewhere herein, including with reference to FIGS. 3-6. Thus, the time delay applied may satisfy the threshold quantity of clock cycles and prevent the write window 270 from becoming too short, thereby improving accuracy and reliability of write operations within the memory system.

FIG. 3 shows an example of an enable signal calibration circuit 300 that supports variable activation time delay for write modes in accordance with examples as disclosed herein. In some cases, aspects of the enable signal calibration circuit 300 may implement or be implemented by aspects of FIGS. 1 and 2. For example, the enable signal calibration circuit 300 may calibrate one or more enable signals 310 used to generate a variable activation time delay for write modes based on one or more timing parameters 305.

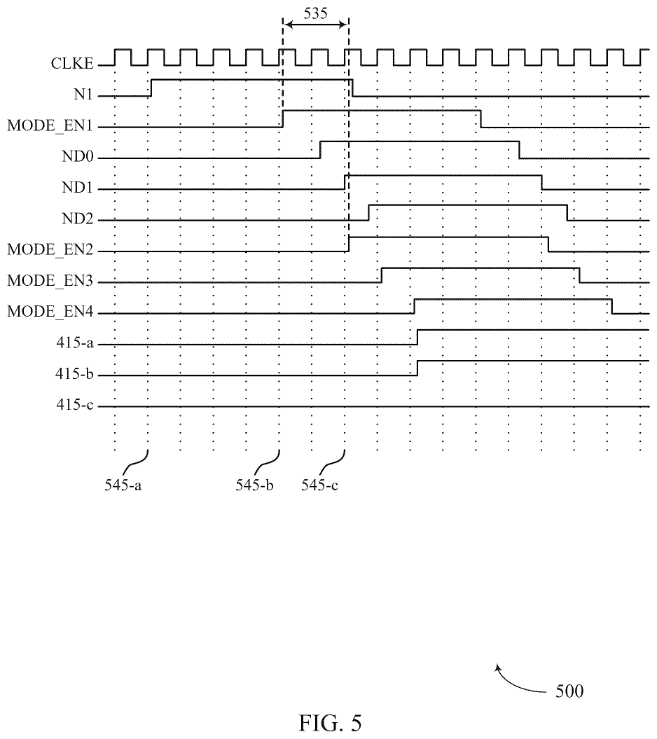

In some cases, the enable signal calibration circuit may be configured to calibrate and output one or more enable signals 310 (e.g., an enable signal 310-a, enable signal 310-b, enable signal 310-c, and enable signal 310-d) associated with generation of one or more control signals (e.g., as described herein with respect to FIGS. 4 and 5) based on one or more timing parameters 305 (e.g., a timing parameter 305-a, a timing parameter 305-b, a timing parameter 305-c, and a timing parameter 305-d). For example, the enable signal calibration circuit 300 may include one or more digital flip flops 320 (e.g., DFFs) configured to assist in generating the enable signals 310. The enable signal calibration circuit 300 may also receive a signal N1, which may be an enable signal for the enable signal calibration circuit 300.

In some cases, the one or more timing parameters 305 may be based on a reset of the memory system, a refresh of the memory system, or both. For example, the memory system may perform a reset (e.g., initialization) sequence, where the reset sequence may include a reset period for transmitting an initialization command (e.g., reset signal, PwrUpRst, power up reset signal), a first nonoperational period for transmitting a first nonoperational command (e.g., nonoperational signal, NOPE2), or both. In some cases, the timing parameter 305-c may be based on the initialization command, and the timing parameter 305-a may be based on the nonoperational command.

Additionally, or alternatively, the memory system may perform a self-refresh sequence. The memory system may change a frequency associated with one or more clocks of the memory system during the self-refresh sequence. The self-refresh sequence may include a frequency change period (e.g., tCSL_FreqChg) for transmitting a frequency change command (e.g., CLKSREFB, when the memory system applies a “self-refresh with frequency change” command), a second nonoperational period for transmitting a second nonoperational command (nonoperational signal, NOPE2, NOPO2, when the memory system exits the “self-refresh with frequency change” command), or both. Additionally, the self-refresh sequence may include a power up reset command (e.g., PwrUpRst), which may be a combination (e.g., an AND combination) of a first signal that may transition from a low state to a high state when an initial voltage supply (e.g., within a section of the memory system) to the memory system during a reset transitions from low to high and a second signal that assumes a low state when the memory system applied a reset. In some cases, the memory system may use the power up reset signal to set an initial value of a programming voltage or one or more other signals of the memory system. In some cases, the timing parameter 305-b may be based on the second nonoperational command, and the timing parameter 305-d may be based on the frequency change command.

Thus, the one or more timing parameters 305 may include one or more of an initialization parameter (e.g., from the initialization command, form the first nonoperational command), a frequency change parameter (e.g., from the frequency change command, from the second nonoperational command), and a self-refresh parameter (e.g., from the frequency change command, from the second nonoperational command) associated with the memory system. The memory system may calibrate the enable signals 310 based on (e.g., after, upon) communication of the initialization command, first nonoperational command, the frequency change command, or the second nonoperational command, or any combination thereof. In some aspects, the calibration and timing of signals associated with the enable signal calibration circuit 300 may be further described herein with respect to FIG. 5.

The enable signal calibration circuit 300 may include one or more other components in addition to the plurality of digital flip flops. For example, the enable signal calibration circuit 300 may include one or more not-AND (NAND) gates, not-OR (NOR) gates, and NOT gates. Additionally, the enable signal calibration circuit 300 may include a subset 325 of the digital flip flops which may reduce metastability issues associated with one or more of the enable signals 310. Thus, the enable signal calibration circuit 300 may receive the timing parameters and the enable signal N1, and may output enable signals 310 according to different delays based on the digital flip flops 320 according to the clock timing (e.g., CLKE) to assist in generation of control signals (e.g., as described herein with respect to FIG. 4).

FIG. 4 shows an example of a control signal generation circuit 400 that supports variable activation time delay for write modes in accordance with examples as disclosed herein. In some cases, aspects of the control signal generation circuit 400 may implement or be implemented by aspects of FIGS. 1-3. For example, the control signal generation circuit 400 may receive one or more of the enable signals 310 as described herein with respect to FIG. 3 to generate one or more control signals 415. In some aspects, a memory system may use the control signal generation circuit 400 to generate one or more control signals 415 (e.g., a control signal 415-a, a control signal 415-b, and a control signal 415-c) for variable activation time delay based on the enable signals 310.

In some cases, the control signal generation circuit 400 may include a default delay element 420 and one or more delay elements 425. In some cases, the default delay element 420 may generate a default delay for the enable signal 310-a (e.g., some defined default delay based on an associated write mode, such as 3.5 clock cycles or 7.5 clock cycles, or some other default delay). the control signal generation circuit 400 may include a plurality of delay paths coupled with an output of the default delay element 420. For example, each delay path of the plurality of delay paths may include at least one of the delay elements 425, and a respective plurality of digital flip flops (e.g., DFFs). In some cases, each digital flip flop of each delay path may receive a respective enable signal 310 of the one or more enable signals 310. For example, a first delay path may begin at the output of the default delay element 420, may include one or more logical components in series (e.g., not-AND (NAND) gates), may generate a signal ND0 after a delay of the one or more logical components and one or more delay elements 425, may input the signal ND0 to one or more digital flip flops, and may output some signal at a given time based on the various delays associated with the first delay path and the various enable signals 310, where the signal may be used to generate at least the control signal 415-a. A second delay path may begin at the output of the default delay element 420, may include one or more logical components in series (e.g., NAND gates), may generate a signal ND1 after a delay of the one or more logical components and the one or more delay elements 425 in the delay path, may input the signal ND1 to one or more digital flip flops, and may output some signal at a given time based on the various delays associated with the second delay path and the various enable signals 310. The signal may be used to generate at the control signal 415-a, the control signal 415-b, or both. A third delay path may begin at the output of the default delay element 420, may include one or more logical components in series (e.g., NAND gates), may generate a signal ND2 after a delay of the one or more logical components and the one or more delay elements 425 in the third delay path, may input the signal ND2 to one or more digital flip flops, and may output some signal at a given time based on the various delays associated with the third delay path and the various enable signals 310 applied to the digital flip flops. The signal may be used to generate the control signal 415-a, the control signal 415-b, the control signal 415-c, or any combination thereof. In some cases, a set of digital flip flops that are each from a respective delay path and receive a same enable signal may form a dice latch 450.

In some cases, the control signal generation circuit 400 may generate the one or more control signals 415 based on a timing difference between the enable signal 310-a and the enable signal 310-b (e.g., as described herein with respect to FIG. 5). In some cases, the timing difference between the enable signal 310-a and the enable signal 310-b may be based on the one or more timing parameters 305, as described herein with respect to FIG. 3. For example, based on the enable signal calibration circuit 300, the timing difference between the enable signals 310-a and 310-b may approximately equal to the threshold quantity of clock cycles as described herein with respect to FIGS. 2A and 2B. In some aspects, the timing difference, as well as the timing of the various signals associated with the control signal generation circuit 400 may be further described herein with respect to FIG. 5.

The control signal generation circuit 400 may receive one or more other signals that may assist in generation of the control signals 415. For example, the control signal generation circuit 400 may receive a calibration signal 430 (e.g., tmfz_BC8dly_calibration_DIS), and one or more other signals 435 (e.g., another signal 435-a, another signal 435-b, and another signal 435-c) from a register of the memory system (e.g., tmfz_BC8_DLY<0:2>).

In some cases, the control signals 415 may be represented by (e.g., stored in) a register. For example, the register may have a quantity of entries corresponding to the quantity of control signals. In some cases, the register for the control signals is known as the write BC8 delay register (e.g., WR_BC8_DLY). Thus, each entry of the register may be set according to the control signal generation circuit 400 such that a delay from a delay circuit 600 (e.g., as described herein with respect to FIG. 6) may approximate the threshold quantity of clock cycles as described herein with respect to FIGS. 2A and 2B.

FIG. 5 shows an example of a timing diagram 500 that supports variable activation time delay for write modes in accordance with examples as disclosed herein. In some cases, aspects of the timing diagram 500 may implement or be implemented by aspects of FIGS. 1-4. For example, the timing diagram 500 may illustrate multiple signals within a memory system implementing activation time delay for write modes, which may be described herein with respect to FIGS. 2-4. For example, the timing diagram 500 may include a clock signal (e.g., CLKE, a clock signal of the memory system, as described herein with respect to FIGS. 1-4), an N1 signal (e.g., as described herein with respect to FIG. 3), a plurality of enable signals (e.g., MODE_EN1, MODE_EN2, MODE_EN3, and MODE_EN4, which may be examples of enable signals 310-a, 310-b, 310-c, and 310-d, respectively, as described herein with respect to FIGS. 3 and 4), an ND0, ND1, and ND2 signal (e.g., as described herein with respect to FIG. 4) and a plurality of control signals 415 (e.g., a control signal 415-a, a control signal 415-b, and a control signal 415-c, as described herein with respect to FIG. 4). In some aspects, the timing diagram 500 may illustrate a timing of multiple signals for variable activation time delay for write modes.

In some aspects, activation of each of the control signals 415 may be based on a time difference 535 between activation of MODE_EN1 and MODE_EN2. For example, a quantity (e.g., 0, 1, 2, 3, etc.) of ND signals (e.g., ND0, ND1, ND2) may be activated after an activation of MODE_EN1 and before an activation of MODE_EN2. The time difference 535 may approximate the threshold quantity of clock cycles (e.g., four clock cycles) as described herein with respect to FIGS. 2A and 2B, and thus the memory system may capture MODE_EN1 at the activation (e.g., rising edge) of MODE_EN2, such that the ND signals, which are activated within the time difference 535 (e.g., based on a corresponding delay path of the control signal generation circuit 400 and the enable signals 310), may correspond to a delay path that outputs a control signal 415 that is activated. Alternatively, each ND signal that is not activated within the time difference 535 may correspond to a delay path that outputs a control signal 415 that is not activated.

For example, at (e.g., or near) a time 545-a, the memory system may activate N1 (e.g., an enable signal for the enable signal calibration circuit 300). At (e.g., or near) the time 545-b, based on the enable signal calibration circuit 300 and N1, MODE_EN1 may be activated. the control signal generation circuit 400 may receive the activated MODE_EN1 (e.g., enable signal 310-a) as an input at (e.g., or near) the time 545-b. ND0 and ND1 may be activated after the time 545-b at which the MODE_EN1 is activated based on respective delays associated with each respective delay path of the control signal generation circuit 400 (e.g., based on the first and second delay paths described with reference to FIG. 3).

At (e.g., or near) a time 545-c, and while N1 is activated, MODE_EN2 may be activated based on the enable signal calibration circuit 300 and the timing parameters 305, such that a difference in time between activation of MODE_EN1 and activation of MODE_EN2 may approximate the threshold quantity of clock cycles (e.g., four clock cycles) as described herein with respect to FIGS. 2A and 2B. However, ND2 may be deactivated at the time 545-c. Thus, based on the ND signals, the control signal 415-a and the control signal 415-b (e.g., corresponding to the delay paths of ND0 and ND1, respectively) may be configured with active signals (e.g., high voltages), and the control signal 415-c (e.g., corresponding to the delay path of ND2) may be configured with an inactive signal (e.g., a low voltage). As described with respect to FIG. 6, a delay circuit 600 may receive the control signals 415 and apply the delay to a write operation based on the control signals 415.

Although FIG. 5 illustrates an example in which the control signals 415-a and 415-b are activated and the control signal 415-c is not activated, it is to be understood that, in some examples, any combination of the control signals 415 or none of the control signals may be activated based on the various timing parameters 305. For example, the enable signal calibration circuit 300 may generate the enable signals 310 (e.g., MODE_EN1 through MODE_EN4) at various different times based on the different timing parameters 305, and the relative activation timings at which the enable signals are applied to the control signal generation circuit 400 may correspond to activation of different control signals 415. The memory system may thereby utilize the enable signal calibration circuit 300 and the control signal generation circuit 400 to test and identify an adequate delay to be applied for certain write operations based on one or more conditions associated with the memory system. The delay may be applied by a delay circuit 600, as described in further detail elsewhere herein, including with reference to FIG. 6.

FIG. 6 shows an example of the delay circuit 600 that supports variable activation time delay for write modes in accordance with examples as disclosed herein. In some cases, aspects of the delay circuit 600 may implement or be implemented by aspects of FIGS. 1-5. For example, the delay circuit 600 may receive one or more control signals 415 as described herein with respect to FIGS. 4 and 5. The delay circuit 600 may also receive a first signal 650 and may output a second signal 655 with a delay applied based on the delay circuit 600, where the second signal 655 may be an example of DWLoad15 as described herein with respect to FIGS. 2A and 2B. Additionally, the delay circuit 600 may include a default delay element 620, which may be an example of the default delay element 420 as described herein with respect to FIG. 4. In some aspects, a memory system may use the delay circuit 600 to apply a variable activation time delay for write modes based on one or more control signals 415.

In some cases, the delay circuit 600 may include a plurality of delay subcircuits 630. Each delay subcircuit may include at least one delay element 625, and the delay circuit 600 may receive each of the control signals 415 at a respective delay subcircuit 630 (e.g., each delay subcircuit 630 may receive a respective control signal 415). Based on the control signals 415, the delay circuit 600 may activate one or more of the delay subcircuits 630 (e.g., one or more of the delay elements 625) to generate a delay between a first time at which a repeater (e.g., the repeater 210 as describe herein with respect to FIGS. 2A and 2B) forwards first data to a set of banks (e.g., based on a first write operation and according to the first write mode) and a second time at which the repeater forwards second data to the set of banks (e.g., based on a second write operation and according to the first write mode), as described herein with respect to FIGS. 2A and 2B.

For example, (e.g., in the example described with respect to FIG. 5), the control signal 415-a and the control signal 415-b may be activated control signals based on the control signal generation circuit 400. Accordingly, the first signal 650 may pass through a delay element 625-a associated with the delay subcircuit 630-a based on the control signal 415-a being activated and through a delay element 625-b associated with the delay subcircuit 630-b based on the control signal 415-b being activated. However (e.g., in one example), the first signal 650 may not pass through a delay element 625-c associated with the delay subcircuit 630-c based on the control signal 415-c being deactivated. Thus, the second signal 655 may include a variable activation time delay based on a write mode of the write operation, the enable signal calibration circuit 300, the control signal generation circuit 400, and the delay circuit 600.

In some examples, if the control signal 415-c is also activated, the first signal 650 may pass through each of the delay elements 625-a, 625-b, and 625-c, which may increase a duration of the delay overall. Additionally, or alternatively, only one of the control signals 415 may be activated, which may reduce the duration of the delay, or some other combination of control signals 415 may be activated. The duration of the delay may thereby be variable based on the control signals 415 generated by the enable signal calibration circuit 300 and the control signal generation circuit 400, as described with reference to FIGS. 3 and 4.

Additionally, or alternatively, the delay circuit 600 may include the default delay element 620 (e.g., a second delay element). In some cases, the default delay element 620 may be coupled with the delay circuit 600, and the default delay element 620 may generate a second delay. For example, a total delay between the first time and the second time may be based on a sum of a delay from the delay subcircuits 630 and the second delay from the default delay element 620. Thus, based on the delay for the delay subcircuits 630, the second delay, or both, a delay of the second signal 655 (e.g., DWLoad15, as described herein with respect to FIGS. 2A and 2B) may approach (e.g., be equal to, be within a threshold difference from) the threshold quantity of clock cycles described herein with respect to FIGS. 2A and 2B.

The delay circuit 600 may be positioned within one or more locations of a memory system. In some examples, the delay circuit 600 may be included in a generation block for a given memory device, which may correspond to a block of circuitry configured to generate the DWload15 signal, as described with reference to FIGS. 2A and 2B. The delay circuit 600 may thereby increase a time between a first DWLoad15 signal and a second DWLoad15 signal, which may effectively increase the write window 270, as illustrated in FIGS. 2A and 2B.

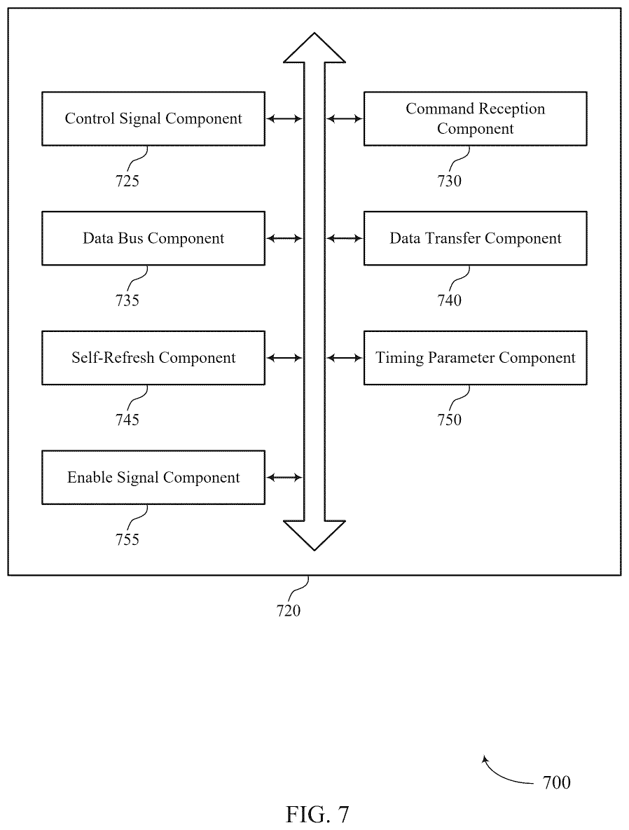

FIG. 7 shows a block diagram 700 of a memory system 720 that supports variable activation time delay for write modes in accordance with examples as disclosed herein. The memory system 720 may be an example of aspects of a memory system as described with reference to FIGS. 1 through 6. The memory system 720, or various components thereof, may be an example of means for performing various aspects of variable activation time delay for write modes as described herein. For example, the memory system 720 may include a control signal component 725, a command reception component 730, a data bus component 735, a data transfer component 740, a self-refresh component 745, a timing parameter component 750, an enable signal component 755, or any combination thereof. Each of these components, or components of subcomponents thereof (e.g., one or more processors, one or more memories), may communicate, directly or indirectly, with one another (e.g., via one or more buses).

The memory system 720 may support operating a memory system in accordance with examples as disclosed herein. The control signal component 725 may be configured as or otherwise support a means for generating a plurality of control signals that indicate a delay time for delaying write operations associated with a write mode (e.g., first write mode) of the memory system, where the delay time is based at least in part on a burst length associated with the write mode and one or more timing parameters associated with the memory system. The command reception component 730 may be configured as or otherwise support a means for receiving a write command that indicates a plurality of write operations for transferring, via a data bus of the memory system, data for storage in a set of banks of the memory system, where a first write operation of the plurality of write operations indicates first data for storage in the set of banks and a second write operation of the plurality of write operations indicates second data for storage in the set of banks. The data bus component 735 may be configured as or otherwise support a means for enabling the data bus based at least in part on the write command. The data transfer component 740 may be configured as or otherwise support a means for initiating, at a first time after enabling the data bus and before initiation of the second write operation, a transfer of the first data associated with the first write operation to the set of banks via the data bus according to the write mode. In some examples, the data transfer component 740 may be configured as or otherwise support a means for initiating, at a second time after transferring the first data via the data bus, transfer of the second data associated with the second write operation via the data bus according to the write mode, where a time period between the first time and the second time is based at least in part on the delay time indicated by the plurality of control signals.

In some examples, the first write operation and the second write operation are consecutive write operations associated with the set of banks.

In some examples, the write command indicates the write mode selected for the first write operation and for the second write operation from a plurality of write modes supported by the memory system, the plurality of write modes including at least the write mode and a second write mode. In some examples, the write mode is associated with a burst length of eight bits and the second write mode is associated with a burst length of sixteen bits.

In some examples, to support generating the plurality of control signals, the control signal component 725 may be configured as or otherwise support a means for providing, at a third time associated with a first enable signal of a plurality of enable signals, the first enable signal to an input of a delay circuit of the memory system, where the delay circuit includes a plurality of delay paths associated with a plurality of delay times. In some examples, to support generating the plurality of control signals, the control signal component 725 may be configured as or otherwise support a means for activating, at a fourth time associated with a second enable signal of the plurality of enable signals, one or more latches coupled with outputs of the plurality of delay paths of the delay circuit, where the one or more latches are configured to output one or more signals associated with one or more of the plurality of delay paths based at least in part on a timing difference between the third time associated with the first enable signal and the fourth time associated with the second enable signal. In some examples, to support generating the plurality of control signals, the control signal component 725 may be configured as or otherwise support a means for generating the plurality of control signals based at least in part on the one or more signals output by the one or more latches.

In some examples, the self-refresh component 745 may be configured as or otherwise support a means for performing a self-refresh operation associated with a change in frequency of the memory system. In some examples, the timing parameter component 750 may be configured as or otherwise support a means for generating the one or more timing parameters based at least in part on a first nonoperational command associated with a reset of the memory system and a second nonoperational command associated with the change in the frequency of the memory system. In some examples, the enable signal component 755 may be configured as or otherwise support a means for generating, based at least in part on the one or more timing parameters and a plurality of logical components, the plurality of enable signals.

In some examples, the one or more timing parameters associated with the memory system include one or more of an initialization parameter, a frequency change parameter, and a self-refresh parameter associated with the memory system.

In some examples, the described functionality of the memory system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 720, or various components thereof, may be implemented at least in part by instructions (e.g., stored in memory, non-transitory computer-readable medium) executable by such at least one processor.

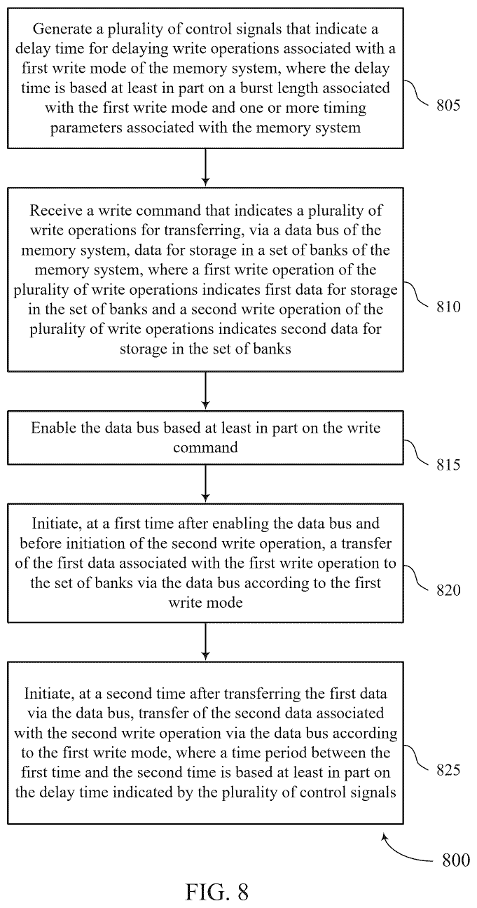

FIG. 8 shows a flowchart illustrating a method 800 that supports variable activation time delay for write modes in accordance with examples as disclosed herein. The operations of method 800 may be implemented by a memory system or its components as described herein. For example, the operations of method 800 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 805, the method may include generating a plurality of control signals that indicate a delay time for delaying write operations associated with a write mode of the memory system, where the delay time is based at least in part on a burst length associated with the write mode and one or more timing parameters associated with the memory system. In some examples, aspects of the operations of 805 may be performed by a control signal component 725 as described with reference to FIG. 7.

At 810, the method may include receiving a write command that indicates a plurality of write operations for transferring, via a data bus of the memory system, data for storage in a set of banks of the memory system, where a first write operation of the plurality of write operations indicates first data for storage in the set of banks and a second write operation of the plurality of write operations indicates second data for storage in the set of banks. In some examples, aspects of the operations of 810 may be performed by a command reception component 730 as described with reference to FIG. 7.

At 815, the method may include enabling the data bus based at least in part on the write command. In some examples, aspects of the operations of 815 may be performed by a data bus component 735 as described with reference to FIG. 7.

At 820, the method may include initiating, at a first time after enabling the data bus and before initiation of the second write operation, a transfer of the first data associated with the first write operation to the set of banks via the data bus according to the write mode. In some examples, aspects of the operations of 820 may be performed by a data transfer component 740 as described with reference to FIG. 7.

At 825, the method may include initiating, at a second time after transferring the first data via the data bus, transfer of the second data associated with the second write operation via the data bus according to the write mode, where a time period between the first time and the second time is based at least in part on the delay time indicated by the plurality of control signals. In some examples, aspects of the operations of 825 may be performed by a data transfer component 740 as described with reference to FIG. 7.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for generating a plurality of control signals that indicate a delay time for delaying write operations associated with a write mode (e.g., a first write mode) of the memory system, where the delay time is based at least in part on a burst length associated with the write mode and one or more timing parameters associated with the memory system; receiving a write command that indicates a plurality of write operations for transferring, via a data bus of the memory system, data for storage in a set of banks of the memory system, where a first write operation of the plurality of write operations indicates first data for storage in the set of banks and a second write operation of the plurality of write operations indicates second data for storage in the set of banks; enabling the data bus based at least in part on the write command; initiating, at a first time after enabling the data bus and before initiation of the second write operation, a transfer of the first data associated with the first write operation to the set of banks via the data bus according to the write mode; and initiating, at a second time after transferring the first data via the data bus, transfer of the second data associated with the second write operation via the data bus according to the write mode, where a time period between the first time and the second time is based at least in part on the delay time indicated by the plurality of control signals.
Aspect 2: The method, apparatus, or non-transitory computer-readable medium of aspect 1, where the first write operation and the second write operation are consecutive write operations associated with the set of banks.
Aspect 3: The method, apparatus, or non-transitory computer-readable medium of any of aspects 1 through 2, where the write command indicates the write mode selected for the first write operation and for the second write operation from a plurality of write modes supported by the memory system, the plurality of write modes including at least the write mode and a second write mode and the write mode is associated with a burst length of eight bits and the second write mode is associated with a burst length of sixteen bits.
Aspect 4: The method, apparatus, or non-transitory computer-readable medium of any of aspects 1 through 3, where generating the plurality of control signals includes operations, features, circuitry, logic, means, or instructions, or any combination thereof for providing, at a third time associated with a first enable signal of a plurality of enable signals, the first enable signal to an input of a delay circuit of the memory system, where the delay circuit includes a plurality of delay paths associated with a plurality of delay times; activating, at a fourth time associated with a second enable signal of the plurality of enable signals, one or more latches coupled with outputs of the plurality of delay paths of the delay circuit, where the one or more latches are configured to output one or more signals associated with one or more of the plurality of delay paths based at least in part on a timing difference between the third time associated with the first enable signal and the fourth time associated with the second enable signal; and generating the plurality of control signals based at least in part on the one or more signals output by the one or more latches.
Aspect 5: The method, apparatus, or non-transitory computer-readable medium of aspect 4, further including operations, features, circuitry, logic, means, or instructions, or any combination thereof for performing a self-refresh operation associated with a change in frequency of the memory system; generating the one or more timing parameters based at least in part on a first nonoperational command associated with a reset of the memory system and a second nonoperational command associated with the change in the frequency of the memory system; and generating, based at least in part on the one or more timing parameters and a plurality of logical components, the plurality of enable signals.
Aspect 6: The method, apparatus, or non-transitory computer-readable medium of any of aspects 1 through 5, where the one or more timing parameters associated with the memory system include one or more of an initialization parameter, a frequency change parameter, and a self-refresh parameter associated with the memory system.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 7: A memory system, including: a first set of banks within a memory array; a second set of banks within the memory array; a data bus configured to communicate data with the second set of banks; a repeater coupled with the data bus and configured to forward first data to the second set of banks according to a write mode based at least in part on a first write operation and to forward second data to the second set of banks according to the write mode based at least in part on a second write operation; and a delay circuit including a plurality of delay elements, where the delay circuit is configured to receive one or more control signals and activate, based at least in part on the one or more control signals, one or more delay elements of the plurality of delay elements to generate a delay between a first time at which the repeater forwards the first data to the second set of banks and a second time at which the repeater forwards the second data to the second set of banks, and where the delay is based at least in part on one or more timing parameters associated with the memory system.
Aspect 8: The memory system of aspect 7, further including: an enable signal calibration circuit including a plurality of digital flip flops, where the enable signal calibration circuit is configured to calibrate and output, based at least in part on the one or more timing parameters, one or more enable signals associated with generation of the one or more control signals.
Aspect 9: The memory system of aspect 8, where the one or more timing parameters are based at least in part on a first nonoperational command associated with a reset of the memory system, a second nonoperational command associated with a frequency change at the memory system, or both.
Aspect 10: The memory system of any of aspects 7 through 9, further including: a control signal generation circuit configured to generate and output the one or more control signals based at least in part on one or more enable signals, where the control signal generation circuit includes: a second delay element configured to generate, based at least in part on a first enable signal of the one or more enable signals, a second delay; and a plurality of delay paths coupled with an output of the second delay element, where each delay path of the plurality of delay paths includes at least one third delay element and a respective plurality of digital flip flop components, and where each second digital flip flow component of each respective plurality of second digital flip flop components is configured to receive a respective enable signal of the one or more enable signals.
Aspect 11: The memory system of aspect 10, where the control signal generation circuit is configured to generate the one or more control signals based at least in part on a timing difference between the first enable signal and a second enable signal of the one or more enable signals, the timing difference is based at least in part on the one or more timing parameters.
Aspect 12: The memory system of any of aspects 7 through 11, further including: a second delay element coupled with the delay circuit and configured to generate a second delay, where a total delay between the first time and the second time is based at least in part on a sum of the delay and the second delay.
Aspect 13: The memory system of any of aspects 7 through 12, where the one or more timing parameters associated with the memory system include one or more of an initialization parameter, a frequency change parameter, and a self-refresh parameter associated with the memory system.
Aspect 14: The memory system of any of aspects 7 through 13, where the first write operation and the second write operation are consecutive write operations associated with the second set of banks.
Aspect 15: The memory system of any of aspects 7 through 14, where the write mode is one of a plurality of write modes supported by the memory system, the plurality of write modes including at least the write mode and a second write mode, and the write mode is associated with a burst length of eight bits and the second write mode is associated with a burst length of sixteen bits.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a first set of banks within a memory array;
a second set of banks within the memory array;
a data bus configured to communicate data with the second set of banks;
a repeater coupled with the data bus and configured to forward first data to the second set of banks according to a write mode based at least in part on a first write operation and to forward second data to the second set of banks according to the write mode based at least in part on a second write operation; and
a delay circuit comprising a plurality of delay elements, wherein the delay circuit is configured to receive one or more control signals and activate, based at least in part on the one or more control signals, one or more delay elements of the plurality of delay elements to generate a delay between a first time at which the repeater forwards the first data to the second set of banks and a second time at which the repeater forwards the second data to the second set of banks, and wherein the delay is based at least in part on one or more timing parameters associated with the memory system.

2. The memory system of claim 1, further comprising:
an enable signal calibration circuit comprising a plurality of digital flip flops, wherein the enable signal calibration circuit is configured to calibrate and output, based at least in part on the one or more timing parameters, one or more enable signals associated with generation of the one or more control signals.

3. The memory system of claim 2, wherein the one or more timing parameters are based at least in part on a first nonoperational command associated with a reset of the memory system, a second nonoperational command associated with a frequency change at the memory system, or both.

4. The memory system of claim 1, further comprising:
a control signal generation circuit configured to generate and output the one or more control signals based at least in part on one or more enable signals, wherein the control signal generation circuit comprises:
a second delay element configured to generate, based at least in part on a first enable signal of the one or more enable signals, a second delay; and
a plurality of delay paths coupled with an output of the second delay element, wherein each delay path of the plurality of delay paths comprises at least one third delay element and a respective plurality of digital flip flop components, and wherein each second digital flip flow component of each respective plurality of second digital flip flop components is configured to receive a respective enable signal of the one or more enable signals.

5. The memory system of claim 4, wherein the control signal generation circuit is configured to generate the one or more control signals based at least in part on a timing difference between the first enable signal and a second enable signal of the one or more enable signals, and wherein the timing difference is based at least in part on the one or more timing parameters.

6. The memory system of claim 1, further comprising:
a second delay element coupled with the delay circuit and configured to generate a second delay, wherein a total delay between the first time and the second time is based at least in part on a sum of the delay and the second delay.

7. The memory system of claim 1, wherein the one or more timing parameters associated with the memory system comprise one or more of an initialization parameter, a frequency change parameter, and a self-refresh parameter associated with the memory system.

8. The memory system of claim 1, wherein the first write operation and the second write operation are consecutive write operations associated with the second set of banks.

9. The memory system of claim 1, wherein the write mode is one of a plurality of write modes supported by the memory system, the plurality of write modes comprising at least the write mode and a second write mode, and wherein the write mode is associated with a burst length of eight bits and the second write mode is associated with a burst length of sixteen bits.

10. A method for operating a memory system, comprising:
generating a plurality of control signals that indicate a delay time for delaying write operations associated with a write mode of the memory system, wherein the delay time is based at least in part on a burst length associated with the write mode and one or more timing parameters associated with the memory system;
receiving a write command that indicates a plurality of write operations for transferring, via a data bus of the memory system, data for storage in a set of banks of the memory system, wherein a first write operation of the plurality of write operations indicates first data for storage in the set of banks and a second write operation of the plurality of write operations indicates second data for storage in the set of banks;
enabling the data bus based at least in part on the write command;
initiating, at a first time after enabling the data bus and before initiation of the second write operation, a transfer of the first data associated with the first write operation to the set of banks via the data bus according to the write mode; and
initiating, at a second time after transferring the first data via the data bus, transfer of the second data associated with the second write operation via the data bus according to the write mode, wherein a time period between the first time and the second time is based at least in part on the delay time indicated by the plurality of control signals.

11. The method of claim 10, wherein the first write operation and the second write operation are consecutive write operations associated with the set of banks.

12. The method of claim 10, wherein the write command indicates the write mode selected for the first write operation and for the second write operation from a plurality of write modes supported by the memory system, the plurality of write modes comprising at least the write mode and a second write mode, and wherein the write mode is associated with a burst length of eight bits and the second write mode is associated with a burst length of sixteen bits.

13. The method of claim 10, wherein generating the plurality of control signals comprises:
providing, at a third time associated with a first enable signal of a plurality of enable signals, the first enable signal to an input of a delay circuit of the memory system, wherein the delay circuit comprises a plurality of delay paths associated with a plurality of delay times;
activating, at a fourth time associated with a second enable signal of the plurality of enable signals, one or more latches coupled with outputs of the plurality of delay paths of the delay circuit, wherein the one or more latches are configured to output one or more signals associated with one or more of the plurality of delay paths based at least in part on a timing difference between the third time associated with the first enable signal and the fourth time associated with the second enable signal; and
generating the plurality of control signals based at least in part on the one or more signals output by the one or more latches.

14. The method of claim 13, further comprising:
performing a self-refresh operation associated with a change in frequency of the memory system;
generating the one or more timing parameters based at least in part on a first nonoperational command associated with a reset of the memory system and a second nonoperational command associated with the change in the frequency of the memory system; and
generating, based at least in part on the one or more timing parameters and a plurality of logical components, the plurality of enable signals.

15. The method of claim 10, wherein the one or more timing parameters associated with the memory system comprise one or more of an initialization parameter, a frequency change parameter, and a self-refresh parameter associated with the memory system.

16. An apparatus for operating a memory system, comprising:
one or more memories storing processor-executable code; and
one or more processors coupled with the one or more memories and individually or collectively operable to execute the code to cause the apparatus to:
generate a plurality of control signals that indicate a delay time for delaying write operations associated with a write mode of the memory system, wherein the delay time is based at least in part on a burst length associated with the write mode and one or more timing parameters associated with the memory system;
receive a write command that indicates a plurality of write operations for transferring, via a data bus of the memory system, data for storage in a set of banks of the memory system, wherein a first write operation of the plurality of write operations indicates first data for storage in the set of banks and a second write operation of the plurality of write operations indicates second data for storage in the set of banks;
enable the data bus based at least in part on the write command;
initiate, at a first time after enabling the data bus and before initiation of the second write operation, a transfer of the first data associated with the first write operation to the set of banks via the data bus according to the write mode; and
initiate, at a second time after transferring the first data via the data bus, transfer of the second data associated with the second write operation via the data bus according to the write mode, wherein a time period between the first time and the second time is based at least in part on the delay time indicated by the plurality of control signals.

17. The apparatus of claim 16, wherein the first write operation and the second write operation are consecutive write operations associated with the set of banks.

18. The apparatus of claim 16, wherein the write command indicates the write mode selected for the first write operation and for the second write operation from a plurality of write modes supported by the memory system, the plurality of write modes comprising at least the write mode and a second write mode, and wherein the write mode is associated with a burst length of eight bits and the second write mode is associated with a burst length of sixteen bits.

19. The apparatus of claim 16, wherein, to generate the plurality of control signals, the one or more processors are individually or collectively operable to execute the code to cause the apparatus to:
provide, at a third time associated with a first enable signal of a plurality of enable signals, the first enable signal to an input of a delay circuit of the memory system, wherein the delay circuit comprises a plurality of delay paths associated with a plurality of delay times;
activate, at a fourth time associated with a second enable signal of the plurality of enable signals, one or more latches coupled with outputs of the plurality of delay paths of the delay circuit, wherein the one or more latches are configured to output one or more signals associated with one or more of the plurality of delay paths based at least in part on a timing difference between the third time associated with the first enable signal and the fourth time associated with the second enable signal; and
generate the plurality of control signals based at least in part on the one or more signals output by the one or more latches.

20. The apparatus of claim 19, wherein the one or more processors are individually or collectively further operable to execute the code to cause the apparatus to:
perform a self-refresh operation associated with a change in frequency of the memory system;
generate the one or more timing parameters based at least in part on a first nonoperational command associated with a reset of the memory system and a second nonoperational command associated with the change in the frequency of the memory system; and
generate, based at least in part on the one or more timing parameters and a plurality of logical components, the plurality of enable signals.
